(19) United States
(12) Patent Application Publication
(10) Pub. No.: US 2003/0189666 A1
(43) Pub. Date: Oct. 9, 2003

(54) Multi-channel digital video broadcast to composite analog video converter

(76) Inventors: Steven Dabell, San Jose, CA (US); Thomas Troksa, San Jose, CA (US)

Correspondence Address: Steve Dabell, 235 E. Santa Clara #804, San Jose, CA, 95113, US

(21) Appl. No.: 10/116,911

(22) Filed: Apr. 8, 2002

(51) Int. Cl. H04N 7/12; H04N 11/02; H04N 11/04

(52) U.S. Cl. 348/389.1

(57) ABSTRACT

A method and apparatus for receiving a digital cable or digital satellite video signal which contains a composite of several digital video channels and converting a plurality of selected channels to analog CATV formatted channels, producing a single composite analog CATV compliant output signal is described. The composite analog CATV output signal is distributed throughout a users premises to one or m ore standard analog televisions, which enables each television to receive digital video content without the need for a dedicated set top box for each television. The apparatus also includes several novel and unique features which enhance the convenience for the user which include selectable re-mapping of specific digital television channels to analog CATV channels, user and service provider conditional access means, television guide means, symbology overlay means, multiple picture in picture means and S-video output means.

### BACKGROUND OF THE INVENTION

This invention relates to devices for processing digital video and more particularly relates to a method and device for the demodulation of digital video and conversion to analog video format.

Digital technology is rapidly becoming the technology of choice for many types of video and audio communications. Efficient data compression techniques and the availability of increased digital signal processing capabilities have enabled more audio and video information to be digitally transmitted in the same bandwidth as analog modulation techniques. Both digital cable and digital satellite television, commonly referred to as DVB take advantage of digital modulation techniques to efficiently deliver an impressive amount of video information to their subscribers.

Today, the vast majority of televisions in use support receiving and demodulating analog video formats which conform to NTSC, PAL or SECAM. Additionally, most modern televisions support receiving analog cable television (CATV) with up to 200 channels. However, digital satellite television (DVB-S) and digital cable (DVB-C) are becoming more common as an efficient means to distribute large amounts of video content. Digital modulation techniques employed in DVB are typically not directly compatible with the majority of analog televisions. Thus, heretofore, in order to view DVB content on an analog television, it has been most common to utilize a separate digital video demodulator which converts the digital video to an appropriate standard analog format which can then be applied to a television which supports the analog format. The device that performs the demodulation and conversion from digital video to analog video is typically referred to as a set-top-box (STB) or integrated receiver decoder (IRD). Heretofore, each IRD is capable of demodulating only one digital video channel and producing an associated video signal modulated in a standard analog video format such as NTSC, PAL or SECAM for viewing on a standard analog television. Thus, in homes which have either digital cable or digital satellite and multiple televisions, it has been necessary to add an IRD and coax cabling for each television to enable viewing of the digital video content. As a result, the cost of adding an IRD for each television, coupled with the installation cost and complexities and compounded by the physically obtrusive nature of an IRD has resulted in a significant barrier to entry for digital cable or digital satellite television. This barrier to entry significantly limits the popularity and growth of digital television services and also presents a burden to the digital cable and satellite television service providers which typically subsidize IRD equipment and installation costs.

It is an object of the present invention to provide an economical, accurate, and physically non-intrusive method and apparatus for converting multiple received DVB channels to analog cable TV (CATV) format such that the composite analog CATV video signal may be distributed over the existing coax cable network which exists in most homes, effectively enabling the digital video content to be distributed throughout the home to multiple televisions without the need for additional set top boxes or cabling for each television. It is another object of the current invention for the apparatus to be implemented into Application Specific Integrated Circuit, such that it may be very economically integrated with existing IRD technology.

### SUMMARY OF INVENTION

It is a general object of the present invention to provide a method for simultaneously converting multiple digital cable and digital satellite video channels to multiple analog CATV formatted channels. It is a more specific object of the present invention to provide a method for simultaneously converting multiple digital cable and digital satellite television channels to standard analog CATV formatted channels which include NTSC, PAL, and SECAM. The present invention provides an innovational design which incorporates state of the art digital signal processing technology to provide precise action, increased accuracy, lower cost, and added functionality over known existing products. The apparatus also includes several novel and unique features which enhance the convenience for the user which include selectable re-mapping of specific digital television channels to analog CATV channels, user and service provider conditional access means, television guide means, symbology overlay means, multiple picture in picture means and S-video output means.

Current analog CATV standards typically support less than 200 channels, while current digital cable and satellite television support up to 1000 channels which implies it is necessary to incorporate a means to enable the user to select which of the available DVB channels to re-map to the available analog CATV channels, preferably, these would be the most commonly viewed channels. The symbology overlay means enables text or graphic information or messages to overlay the video signal and convey a message to the user, such as channel re-map information, messages from the service provider and television guide information. The apparatus also includes conditional access functionality which enables either the operator of the device or the service provider to selectively block specific channels form being forwarded as an analog CATV channel. Additionally, conditional access ensures only authorized viewers can access the transported information. This may involve decryption, authentication, signature verification, key distribution, and application of user preferences. To enable the user to rapidly study the content which is currently available, the apparatus includes a picture in picture television guide means which displays on one or more reserved channels, the real time video content of all of the available channels organized as tiled reduced size picture next to picture structure with symbology overlay providing associated channel number, which enables the user to rapidly view all channel content currently available and then select which specific channel to view.

In one aspect of the invention, a method for performing demodulation of a received digital video broadcast signal, which contains a composite of several time and frequency division multiplexed video channels, and conversion to multiple re-modulated analog television channels, includes demodulation of the received digital signal, synchronizing to the demodulated symbol times, forward bit error detection and correction of the composite sampled digital signal, depacketizing of the error corrected composite digital signal into individual digital video and digital audio channels, conditional access qualification of the individual digital video and digital audio channels, selection of a plurality of conditional access qualified digital video and digital audio channels, source decoding of plurality of selected digital video and digital audio channels, conversion of decompressed plurality of selected digital video and digital audio channels to composite analog video and audio format channels, re-modulation of plurality of composite analog video and analog audio channels to desired analog CATV channels to form a composite multi-channel analog CATV complaint signal.

In another aspect of the invention an apparatus for performing demodulation of a received digital video broadcast signal which contains a composite of several digital video channels and conversion to multiple re-modulated analog television channels, includes a demodulator which processes the received digital signal and generates a symbol stream, a forward error correction function which removes and detects bit errors of the composite symbol stream, a de-packetizing function which separates the error corrected composite symbol stream into individual digital video and digital audio channels, a gating function which performs conditional access qualification of the individual digital video and digital audio channels, a selector function which selects a plurality of access qualified digital video and digital audio channels, a plurality of source decoding functions which decompress the plurality of selected digital video and digital audio channels, a plurality of converter functions which convert the source decoded plurality of selected digital video and digital audio channels to composite analog video format channels, and a plurality of re-modulator functions which frequency shift and filter the plurality of composite analog video channels to desired analog CATV channels to form a composite multi-channel analog CATV compliant signal.

Further objects and advantages of the present invention will become apparent to those skilled in the art from a consideration of the following detailed description of the preferred embodiment, drawings and claims.

### DESCRIPTION OF DRAWINGS

FIG. 1 Block diagram of the multi-channel digital video to composite analog CATV converter;

FIG. 2 Illustration of the received digital television satellite spectrum (DSS);

FIG. 3 Illustration of the multichannel modulated analog CATV output;

FIG. 4. System diagram;

### DETAILED DESCRIPTION

The preferred embodiment of the present invention with reference to a multiple channel digital video to composite analog video converter will be described in detail in conjunction with the drawings including theoretical foundation and functional block diagram.

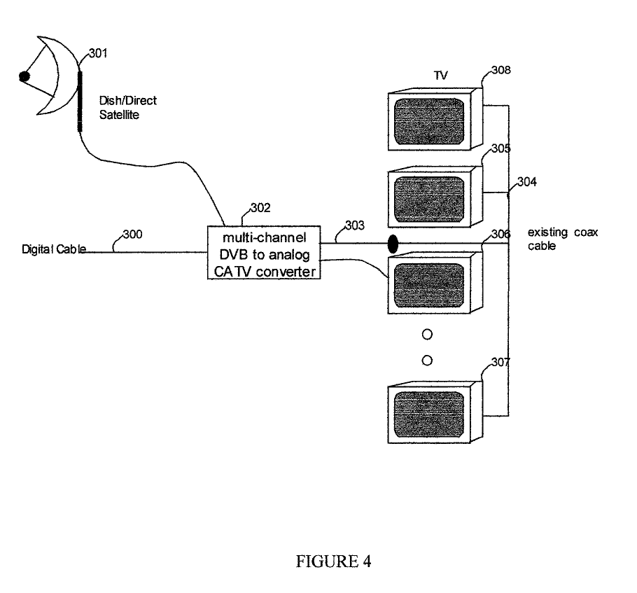

FIG. 4, presents a system diagram detailing the application of the present invention. More specifically, a modulated digital video signal is received either from cable 300 or satellite 301 and is applied to the multi channel digital video to composite analog CATV remodulator 302. The multi-channel digital video to composite analog CATV re-modulator 302, accepts the received digital video signal 300 or 301, which is comprised of many video channels, and converts a plurality of selected channels to analog CATV formatted channels, producing a single composite analog CATV output signal 303. The composite analog CATV output signal 303, is distributed throughout a users premises using the existing cabling 304 which is commonly installed in most homes. The existing cable 304, terminates at one or m ore televisions 305, 306, 307, 308 within the premises, which enables each television to receive digital video content without the need for a dedicated ICD at each television.

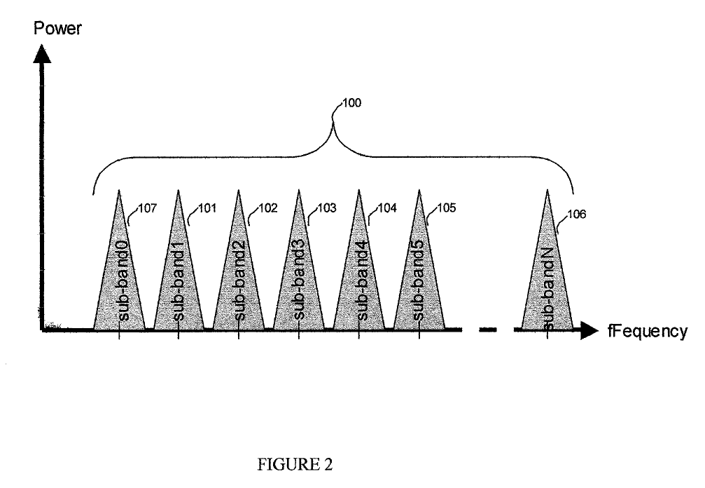

In FIG. 2, the spectrum of a received DVB compliant modulated digital video signal 100 which is applied to the wideband video transceiver input is presented. The modulated digital video signal 100 is comprised of one or more subbands 101, 102, 103, to 107 each of which is individually modulated and frequency division multiplexed (FDM) to form the composite modulated digital video signal 100. Each subband 101, 102, 103 to 107 contains source encoded digital television channels that are time division multiplexed (TDM). In a preferred embodiment of the present invention the modulated digital video signal 100 is Digital Video Broadcast (DVB). In the preferred case of DVB, a plurality of 32 subbands 101, 102, 103 to 107 exist and each subband 101, 102, 103 to 107 is preferably 24 Mhz in bandwidth. Each subband 101, 102, and 103 to 107 contain a signal which is QPSK modulated, and contains between 4 to 8 broadcast television quality MPEG-2 compressed video channels which are TDM to form the composite transponder signal 101, 102, 103 to 107, The total bandwidth of the received DVB signal is approximately 1 GHZ and contains less than 500 compressed video channels.

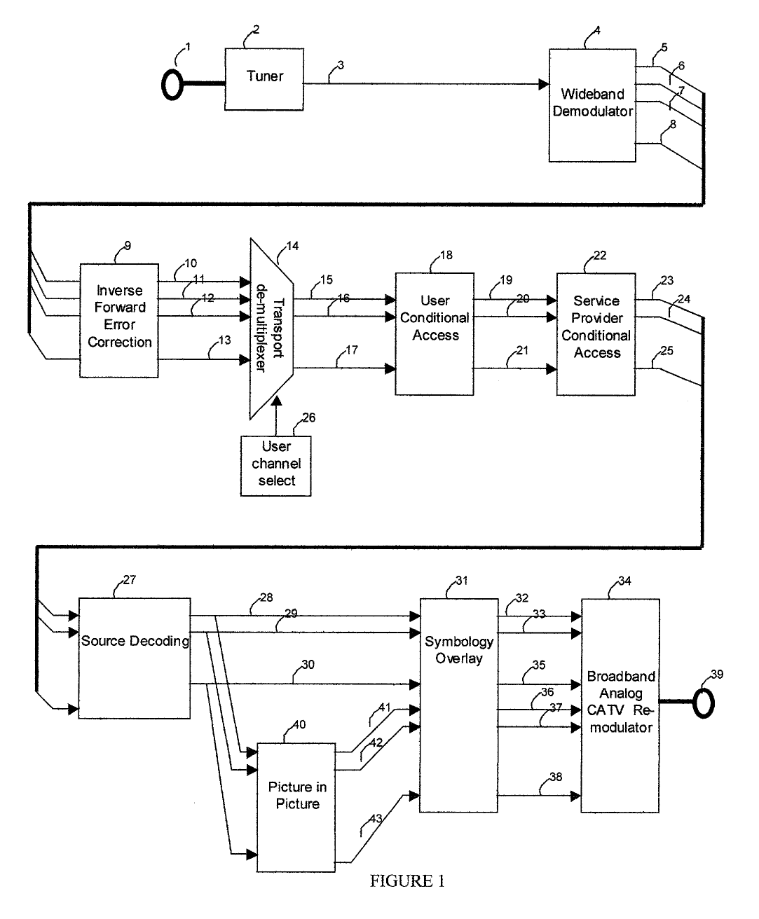

The major elements of the Multi-Channel Digital Video Broadcast to Composite Analog Video Converter are presented in FIG. 1. In FIG. 1, modulated digital video signal 100 is received and applied to the tuner function 2 which filters and quantizes the received signal into sampled form 3. A feature and competitive advantage of present invention includes operating the tuner function 2 at a sampling rate sufficient to quantize the entire spectrum of the received modulated signal 100. In the preferred embodiment where signal 100 is DVB, the sampling rate would be less than 3 Giga samples per second. The quantized signal 3 is then applied to the wideband demodulator function 4.

A feature and advantage of the present invention is that the wideband demodulator function 4 demodulates all subbands 101, 102, 103 to 107 of the quantized signal 3 and produces a symbol stream 5, 6, 7, 8 for each of the associated sub-bands 101 to 107. In the preferred embodiment of DVB, there are less than or equal to 32 symbol streams 5, 6, 7, 8. The demodulated symbol streams 5, 6, 7, 8 are applied to an inverse forward error correction function 9.

Inverse FEC removes transmission coding and corrects any errors that can be detected in each symbol streams 5, 6, 7, 8. The forward error correction function 9 produces an output bit stream 10, 11, 12, 13 associated with each sub-band 101 to 107 which is then applied to a transport de-multiplexer function 14.

The transport de-multiplexer function 14 accepts all bitstreams 10, 11, 12, 13, each of which contain a plurality of TDM source encoded composite digital video channels, and de-packetizes and selects a plurality of channels to he forwarded as output digital video channels 15, 16, 17 and ultimately converted to analog CATV format. The de-multiplexer function 14 is controlled by the user channel selection function 26 which accepts user channel preferences and produces associated control signals to the de-multiplexer function 14 to forward the user requested channels 15, 16, 17. For the preferred emobiment of DVB, the number of compressed composite video channels contained in the bit streams 10, 11, 12, 13 is less than 1000, and the number of output digital video channels 15, 16, 17 is preferably less than 200 which is limited by the number of analog CATV channels available. The output digital video channels 15, 16, 17 are then applied to the user conditional access function 18.

The user conditional access function 18 performs channel blocking functionality based on user selections and produces the user qualified digital video channels 19, 20, 21 which is applied to the service provider conditional access function 22.

The service provider conditional access function 22 determines which of the video channels 19, 20, 21 may be viewed and produce access approved video channel output data 23, 24, 25 for each approved input channel 19, 20, 21. The service provider conditional access function 22 performs decryption, authentication, signature verification, key distribution, and application of user preferences. The approved video channel output data 23, 24, 25 is applied to the source decoding function 27 which is responsible for implementing video and audio decompression which reversed entropy-reducing source coding and produces a raw bit stream for each video channel 28, 29, 30. In the preferred DVB embodiment, the video and audio are compressed in compliance with the MPEG standard.

The source decoder function 27 produces a plurality of decompressed video and audio signals 28, 29, 30 each corresponding to the plurality of applied compressed video qualified channel input 23, 24, 25 with a resolution of preferably less than 800×600 pixels. A feature and advantage of the current invention is that the source decoder function 27 supports decompressing a plurality of video channels simultaneously, preferably less than 200 channels. Each decompressed video and audio channels 28, 29, 30 are applied to the symbology overlay function 31 and picture in picture function 40.

The picture in picture function 40 accepts the plurality of decompressed video and audio signals 28, 29, 30 and produces a plurality of new decompressed summary video signals 41, 42, 43 that consists of reduced size input decompressed video signals 28, 29, 30 tiled in a grid form of picture next to picture, which provides a visual real time television guide of the content that is currently available. The summary video channels 41, 42, 43 and the decompressed video and audio channels 28, 29, 30 are applied to the symbology overlay function 31.

The symbology overlay function 31, adds unique graphic and text symbology overlay to each decompressed video channel input, 28, 29, 30, 41, 42, 43 which may include content such as channel remapping information, channel numbers, time, and messaging information. For each decompressed video and audio channel input 28, 29, 30, 41, 42, 43, the symbology overlay function 31 produces an associated symbology overlayed output video and audio channel plurality of output video and audio channels 32, 33, 35, 36, 37, 38 which are applied to the broadband analog CATV re-modulator 34.

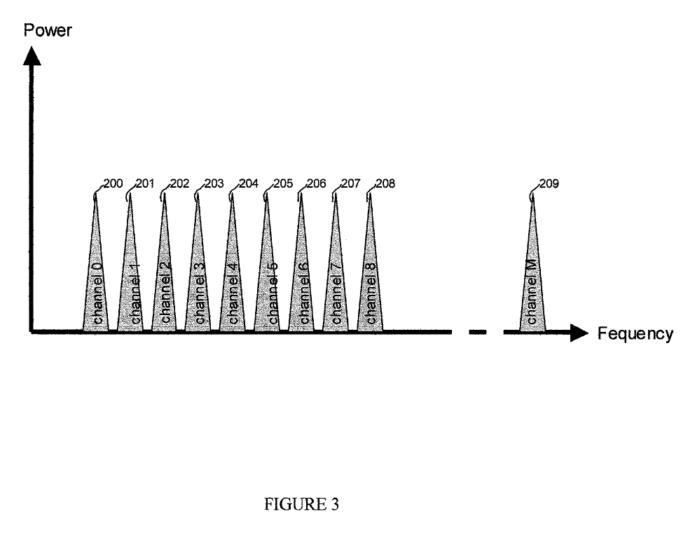

The broadband analog CATV re-modulator 34, converts each of the plurality of decompressed digital video input channels 32, 33, 35, 36, 37, 38 to a unique modulated CATV standard analog channel to form a composite modulated CATV standard analog signal 39, the frequency spectrum 200 of which is presented in FIG. 3. The frequency spectrum 200 of the composite modulated CATV standard analog signal 39, consists of the plurality of unique modulated CATV standard analog channels 201, 202, to 209 each of which correspond to the plurality of decompressed digital video input channels 32, 33, 35, 36, 37, 38. In the preferred embodiment, the composite modulated CATV standard analog signal 39 is compliant with and indistinguishable from a standard analog NTSC CATV signal. Additionally, the broadband analog CATV re-modulator function 34 preferably supports additional modes of operation, to generate modulated CATV compliant analog signals 39 which conform to PAL and SECAM standards.

In summary, a significant feature and advantage of the Multi-Channel Digital Video Broadcast to Composite Analog Video Converter described in the present invention, is to accept a received modulated digital video signal 100 which is DVB compliant, and ultimately convert a plurality of the video channels 15, 16, 17, contained in the received digitally modulated video signal 100 into standard analog CATV format 200. In practice, this Multi-Channel Digital Video Broadcast to Composite Analog Video Converter capability provides the advantage of enabling distribution of DVB content over the standard coaxial cabling which is commonly available throughout most homes and the seamless viewing on common televisions which support analog CATV format. This capability, eliminates the need to have a physically obtrusive separate IRD dedicated for each television, eliminates the need for dedicated cabling to each IRD, reduces installation costs, reduces equipment costs, and provides enhanced features and greater convenience for the consumer.

What is claimed is:

1. An apparatus for demodulating a plurality of received digital video broadcast channels, where in each said plurality of digital video broadcast channels is comprised of video and audio information, and converting and re-modulating said plurality of received digital video broadcast channels to a multi-channel frequency division multiplexed composite analog video signal comprising:
a quantizer means for converting said plurality of received digital video broadcast channels into a composite received sampled signal;
a demodulator means for converting said composite received sampled signal into a plurality of composite symbol streams;
a forward error correction function which corrects bit errors in said plurality of composite symbol streams;
a de-packetizing means for separating said plurality of composite symbol streams into multiple individual digital video channels;
first gating means which qualifies each said individual digital video channels for further processing and produces a plurality of access qualified digital video channels;
second gating means which further qualifies each said access qualified digital video channel and produces a plurality of conditional access qualified digital video channels;
a plurality of source decoding means which decompress said plurality of conditional access qualified digital video channels to produce a plurality of source decoded digital video channels;
a plurality of converter means for transforming the said plurality of source decoded digital video channels to said plurality of composite analog video channels;
a plurality of re-modulator means for frequency translating and combining said plurality of composite analog video channels to form a multi-channel frequency division multiplexed composite analog video signal.

2. Apparatus of claim 1, further comprising a symbology overlay means, which selectively adds text or graphic information to said plurality of composite analog video channels.

3. Apparatus of claim 1, further comprising an audio overlay means, which selectively adds audio information to said plurality of composite analog video channels.

4. Apparatus of claim 1, further comprising a picture in picture means, which selectively tiles reduced size said plurality of composite analog video channels and forms a composite analog video formatted channel comprising said tiled reduced size plurality of composite analog video channels.

5. Apparatus of claim 1 wherein said apparatus is implemented in application specific integrated circuit technology.

6. Apparatus of claim 1, wherein said plurality of received digital video broadcast channels compose a digital video broadcast satellite signal.

7. Apparatus of claim 1, wherein said plurality of received digital video broadcast channels compose a digital video broadcast cable television signal.

8. Apparatus of claim 1, wherein said plurality of received digital video broadcast channels compose an ATSC television signal.

9. Apparatus of claim 1, wherein said plurality of converter means include a multimode means to produce said plurality of composite analog video channels compliant with NTSC, ATSC, SECAM or PAL formats.

10. Apparatus of claim 1, wherein said plurality of re-modulator means further comprise a channel re-mapping means for selectively ordering said plurality of composite analog video channels.

11. Apparatus of claim 1, further comprising a data extraction means to extract data information from said multiple individual digital video channels and combine with said plurality of composite analog video channels.

12. An apparatus for receiving a digital video broadcast signal which contains a plurality of digital video channels, where in each said plurality of digital video channels is comprised of video and audio information, and conversion of a plurality of said digital video channels to a plurality of analog video channels which comprises;
a converter means to transform a plurality of said digital video channels to an equal plurality of analog video channels, wherein each said plurality of analog video channels is comprised of video and audio information;
a modulator means for translating said plurality of analog video channels to unique channel frequencies to form a composite frequency division multiplexed multi-channel analog video signal.

13. Apparatus in claim 12, wherein said received digital video broadcast signal is a digital video broadcast satellite signal.

14. Apparatus in claim 12, wherein said converter means further comprises a multiple mode means to transform said plurality of digital video channels to an equal plurality of NTSC, PAL, SECAM or S-Video compliant analog television signals.

15. Apparatus in claim 12, wherein said modulator means further comprises a channel remapping means for selectively reassigning said plurality of digital video channels to corresponding said plurality of analog video channels which comprise said composite frequency division multiplexed multi-channel analog video signal.

16. Apparatus in claim 12, wherein said converter means further comprises a conditional access means to enable conversion of individual said plurality of said digital video channels to said plurality of analog video channels.

17. Apparatus in claim 12, wherein said converter means further comprises a multiple picture in picture means which extracts and tiles content from a predefined number of individual said plurality of digital video channels to form a new analog video channel.

18. Apparatus in claim 12, wherein said converter means further comprises a symbology overlay means to add unique symbology overlay to said plurality of analog video channels.

19. A method for converting a plurality of digital video broadcast satellite channels, to a plurality of analog formatted channels consisting of the steps of:
demodulating and decoding said plurality of digital video broadcast satellite channels to form a plurality of decoded digital broadcast video channels;
converting said plurality of decoded digital broadcast video channels to form a plurality of NTSC compliant analog video channels;
modulating said plurality of NTSC compliant analog video channels to unique channel frequencies to form a plurality of translated NTSC compliant analog video channels;
combining said plurality of translated NTSC compliant analog video channels to form a composite frequency division multiplexed multi-channel analog television signal.
